(19) United States
(12) Patent Application Publication
(10) Pub. No.: US 2018/0043282 A1
(43) Pub. Date: Feb. 15, 2018

(54) SEPARATING METHOD OF FLUORINE-CONTAINING SOLVENT, REMOVING METHOD OF FLUORINE-CONTAINING SOLVENT CONTAMINANT, AND APPARATUS THEREFORE

(71) Applicant: DUPONT-MITSUI FLUOROCHEMICALS CO,, LTD,, TOKYO (JP)

(72) Inventors: MIKI ITO, Shizuoka (JP); TAKANORI MATSUMOTO, Shizuoka (JP); HIDEAKI KIKUCHI, Shizuoka (JP)

(21) Appl. No.: 15/557,162

(22) PCT Filed: Mar. 4, 2016
(86) PCT No.: PCT/US2016/020847

§ 371 Date: Sep. 11, 2017

(30) Foreign Application Priority Data
Mar. 12, 2015 (JP) 2015-049391

(51) Int. Cl. B01D 11/04; C11D 7/50; C11D 11/00; B01D 71/36

(52) U.S. Cl. CPC B01D 11/0415; B01D 11/0492; B01D 71/36; C11D 7/5018; C11D 11/0047

(57) ABSTRACT

An object of the invention is to separate a fluorine-containing solvent in a short time and efficiently from a fluorine-containing solvent which contains alcohol. There is provided a method for separating a fluorine-containing solvent by filtering a mixed liquid composition containing the fluorine-containing solvent, alcohol and water with a membrane containing fluorine resin.

### FIELD OF THE INVENTION

The present invention relates to a method for separating a fluorine-containing solvent from a mixed liquid composition containing a fluorine-containing solvent, alcohol and water. Particularly, the present invention relates to a method for separating a fluorine-containing solvent by filtering a mixed liquid composition containing a fluorine-containing solvent, alcohol and water with a membrane containing fluorine resin, and a method for removing an alcohol-containing contaminant in fluorine-containing solvent by using such a method, and an apparatus for performing such methods.

### BACKGROUND ART

A fluorine-containing solvent is used in various ways such as a heat-transfer medium, cleaning agent, a coating solvent, and an extract solvent, and particularly has been increasingly demanded as a replacement liquid at the time of wafer cleaning or wafer drying in semiconductor manufacturing apparatus in a semiconductor manufacturing field.

Since particles due to contamination cause poor integrated circuits, the purity of the fluorine-containing solvent used in the semiconductor manufacturing is considered to be important. Thus, inherently, it is desirable to use a new fluorine-containing solvent, however, since the fluorine-containing solvent is relatively expensive, reuse of the fluorine-containing solvent is strongly demanded in the light of cost. Some wafer cleaning or drying processes in the semiconductor manufacturing use alcohol such as isopropyl alcohol (IPA) as well as the fluorine-containing solvent, and the mixed alcohol needs to be removed from the fluorine-containing solvent for reuse.

Examples of fluorine-containing solvents of which reuse is demanded include chlorofluorocarbons (CFCs), perfluorocarbons (PFCs), hydrofluorocarbons (HFCs), hydrofluoroolefin (HFOs), hydrochlorofluorocarbons (HCFCs), hydrochlorofluoroolefins (HCFOs), hydrofluoroethers (HFEs), and perfluoropolyethers (PEPEs), and hydrofluorocarbons or hydrofluoroethers are preferable for use in consideration of effect on the environment. However, hydrofluorocarbons or hydrofluoroethers have relatively high compatibility with alcohol to increase the mixed amount and be likely to become an azeotropic composition when used with alcohol, and thus separation of alcohol from hydrofluorocarbons or hydrofluoroethers by distillation is difficult in many cases. Further, in recent years, fluorine-containing solvents having a high boiling point have been practically used, and in the case where the fluorine-containing solvent and alcohol have similar boiling points, removal by distillation is difficult in many cases.

Under such circumstances, there has been known, as a method for removing alcohol from the fluorine-containing solvent for the purpose of reuse, to add water to the fluorine-containing solvent in which alcohol is mixed and to remove the mixed substances by specific gravity separation (Patent Document 1). However, this method requires time for the separation and needs facilities for mixing and separation in order to process continuously. Further, there is a disadvantage in that at least a certain amount of liquid is required to perform the process.

Furthermore, there also has been known a method for removing alcohol, from a fluorine-containing solvent, wherein alcohol is dissolved into water by using an oil-water separation filter comprising PET, nylon, or the like as a main component (Patent Document 2). However, this method is used as a post-process after static separation, and this kind of filter is expensive and difficult to dispose of, and thus it is not an adequate solution for the case where a large amount of water is contained.

### RELATED ART DOCUMENTS

Patent Document 1: Japanese Examined Patent Application Publication No. S62-56846.

Patent Document 2: Japanese Patent No. 5085954

### SUMMARY OF THE INVENTION

### Problems to be Solved by the Invention

Accordingly, an object of the invention is to separate a fluorine-containing solvent in a short time, efficiently, and at a reasonable cost from a fluorine-containing solvent which contains alcohol even if the fluorine-containing solvent and the alcohol form an azeotropic composition.

### Methods for Solving the Problems

The present inventors have conducted thorough investigation to solve the above problems, and have found that if a mixed liquid composition containing the fluorine-containing solvent, alcohol and water is filtered with a membrane containing fluorine resin, only the fluorine-containing solvent passes through the membrane and can be separated, and thus the present invention has been completed.

Specifically, the present invention has the following features.

1. A method for separating a fluorine-containing solvent by filtering a two-phase mixed liquid composition containing the fluorine-containing solvent, alcohol and water with a membrane containing fluorine resin.

2. A method for removing an alcohol-containing contaminant from a fluorine-containing solvent, the method comprising: adding and mixing water into the fluorine-containing solvent containing the alcohol-containing contaminant to prepare a two-phase mixed liquid composition containing the fluorine-containing solvent, the alcohol, and the water; and thereafter separating the fluorine-containing solvent by filtering the two-phase mixed liquid composition with a membrane containing fluorine resin.

3. The method according to item 1 or 2, wherein the fluorine-containing solvent is a hydrofluorocarbon or a hydrofluoroether.

4. A filtration separation apparatus for performing the method according to any one of items 1 to 3, the filtration separation apparatus comprising a membrane containing fluorine resin.

5. A cleaned fluorine-containing solvent that is obtained by the method according to any one of items 1 to 3.

6. The fluorine-containing solvent according to item 5, wherein the fluorine-containing solvent is for semiconductor cleaning.

### Advantageous Effect of the Invention

According to the fluorine-containing solvent removing method of the present invention, the fluorine-containing solvent can be separated in a short time and efficiently even in the case where a large amount of alcohol is contained, the case where the fluorine-containing solvent and the alcohol form an azeotropic composition, or the case where the fluorine-containing solvent has a high boiling point.

Moreover, according to the fluorine-containing solvent removing method of the present invention, the process can be performed with a small amount of fluorine-containing solvent with no problem.

Further, according to the fluorine-containing solvent removing method of the present invention, not only alcohol but also organic and inorganic ions can be removed at the same time, and therefore efficient regeneration of the fluorine-containing solvent can be achieved.

Furthermore, since the fluorine-containing solvent removing method of the present invention does not require to use expensive filters, it has an advantage in terms of cost.

### EMBODIMENTS FOR CARRYING OUT THE INVENTION

The present invention will be described in detail below.

In the present invention, a two-phase mixed liquid composition refers to a composition that is liquid at room temperature and contains at least a fluorine-containing solvent, alcohol, and water, and is separated in two phases (or may be in a state of suspension).

In the present invention, a fluorine-containing solvent is not limited specifically as far as it is a compound (fluorocarbons) that is a liquid at room temperature and contains fluorine and carbon, and specific examples thereof include: for example, chlorofluorocarbons (CFCs) comprising fluorine and chlorine; perfluorocarbons (PFCs) comprising carbon and fluorine; hydrofluorocarbons (HFCs) comprising carbon, fluorine, and hydrogen; hydrofluoroolefins (HFOs) which is HFCs having an unsaturated bond; hydrochlorofluorocarbons (HCFCs) comprising carbon, fluorine, oxygen, and chlorine; hydrochlorofluoroolefins (HCFOs) comprising carbon, fluorine, oxygen, and chlorine and having an unsaturated bond; hydrofluoroethers (HFEs) comprising carbon, hydrogen, fluorine, and oxygen and having an ether bond, and fluoropolyethers (PFPEs, HFPEs) in which all or a part of hydrogen of a polyether is replaced with fluorine, and may be a mixture of the above.

Considering an environment aspect, the fluorine-containing solvent is preferably hydrofluoroethers or hydrofluorocarbons, which have a low global warming potential (GWP), and more particularly, the GWP of the fluorine-containing solvent is equal to or less than 100, preferably equal to or less than 50, and more preferably equal to or less than 10, and further, an ozone depletion potential of the fluorine-containing solvent is preferably zero.

In the present invention, hydrofluorocarbon is a saturated or unsaturated compound containing only carbon, fluorine, and hydrogen atoms, wherein the number of carbons is 3 to 9 and preferably 4 to 8. Specific examples of hydrofluorocarbon are tridecafluorooctane, decafluoropentane, pentafluorobutane, heptafluorocyclopentane, pentadecafluoroheptane, pentafluoropropane, hexafluorobutene, and the like, and a preferable example is 1,1,1,2,2,3,4,5,5,5-decafluoropentane.

In the present invention, hydrofluoroether is a saturated or unsaturated compound having an ether bond, and comprises carbon, hydrogen, fluorine, and oxygen atoms, wherein the number of carbons is 3 to 9 and preferably 4 to 8. Specific examples of hydrofluoroether are 1,1,1-trifluoroethyl-1,1,2,2-tetrafluoroethylether, nonafluorobutylmethylether, methoxyperfluoroheptene, and the like, and a preferable example is methoxyperfluoroheptene.

In the present invention, the fluorine-containing solvent can be prepared by known methods, but commercially available products may be used.

The commercially available fluorine-containing solvent used in the present invention include: for example, Vertrel® XF, Vertrel® Suprion, Vertrel® MCA, and Vertrel® XH manufactured by Du Pont-Mitsui Fluorochemicals Co, Ltd.; ASAHIKLIN® AC-6000, AMOLEA® series manufactured by Asahi Glass Co., Ltd.; Novec® products, Fluorinert products, manufactured by 3M Japan Limited; and Galden® products manufactured by Solvay Japan, Ltd.; and the like.

In the present invention, alcohol refers to a composition that is liquid at room temperature and soluble in water. Specific examples of alcohol include, for example, lower alcohols such as methanol, ethanol, propanol, and butanol, and polyols such as ethylene glycol.

In the present invention, a membrane containing fluorine resin refers to a filter containing fluorine resin as a main component. Examples of the fluorine resin include polytetrafluoroethylene (PTFE), tetrafluoroethylene-perfluoro (alkyl vinyl ether) copolymer (PFA), tetrafluoroethylene-hexafluoropropylene copolymer (FEP), tetrafluoroethylene-hexafluoropropylene-perfluoro (alkyl vinyl ether) copolymer, tetrafluoroethylene-ethylene copolymer, polyvinylidenefluoride, polychlorotrifluoroethylene, and chlorotrifluoroethylene-ethylene copolymer. Perfluoro resin, such as PTFE, PFA, and FEP, in which the all hydrogen in molecular chains are replaced with fluorine are preferable, and among the above, PTFE is particularly preferable.

Commercially available membranes preferably used in the present invention include, for example, Advantec® PF100, Advantec® PF040, and Advantec® PF020, which are PTFE filters manufactured by Advantec Toyo Kaisha, Ltd.

In the present invention, in addition to the membrane containing fluorine resin, filters other than the membrane containing fluorine resin may be used in order to remove contaminants other than alcohol. Specific examples of the filters other than the membrane containing fluorine resin include a chemical adsorption filter such as an alumina filter for removing fluorine ions, a particle filter, and a physical adsorption filter such as activated carbon and zeolite.

In the present invention, the composition ratio of alcohol and water in the mixed liquid composition is that the amount of water is 1 or more times (mass ratio) greater than the amount of alcohol, particularly 1.5 or more times (mass ratio), and more particularly 2 or more times (mass ratio). If the amount of water is less than 1 times the amount of alcohol, alcohol is not contained in water phase sufficiently to thus cause some alcohol remaining in the fluorine solvent, and further, the concentration of alcohol in the water phase is increased to thus lower the surface tension and cause a risk that liquid passes through the membrane.

In the present invention, an alcohol-containing contaminant refers to, for example, in the case where the fluorine-containing solvent is used in a process such as wafer cleaning and drying process in semiconductor manufacturing, a substance that has been mixed in the fluorine-containing solvent at the time of the above process and should be removed for reuse. Examples of the alcohol-containing contaminant include alcohol, organic and inorganic ions (e.g., carboxylate ions, ammonium ions, fluorine ions, sulfate ions, and various metal ions, such as sodium, potassium, magnesium, zinc, and iron), and other impurities.

Although the alcohol-containing contaminant includes substances generated in the use in fields other than the semiconductor manufacturing field (e.g., cleaning agent, heat transfer medium, cleaning agent, coating solvent (such as coating of optical parts), extract solvent, and other usage where the fluorine-containing solvent is used) or substances mixed from the environment, even in such cases, the regeneration method of the fluorine-containing solvent according to the present invention and the fluorine-containing solvent according to the present invention can be used.

In the present invention, a filtration separation apparatus for performing the method according to the present invention is characterized by comprising a membrane containing fluorine resin, and may further comprise a chemical adsorption filter, a particle filter, a physical adsorption filter, and the like. The filtration separation apparatus according to the present invention, with a compact and simple structure compared to conventional apparatuses, can remove an alcohol-containing contaminant from the fluorine-containing solvent in a short time, can process a small amount of the fluorine-containing solvent with no problem, and further, can maintain the separation performance by appropriately replacing the membrane (mostly PTFE filter) containing fluorine resin.

In the present invention, a cleaned fluorine-containing solvent refers to a fluorine-containing solvent that becomes reusable by the method according to the present invention wherein the fluorine-containing solvent is separated from the mixed liquid composition containing a fluorine-containing solvent, alcohol and water, or the alcohol-containing contaminant is removed from the fluorine-containing solvent. The cleaned fluorine-containing solvent is reused, for example, in semiconductor cleaning (including the use as a replacement liquid at the time of wafer cleaning or drying).

The content of water, in the fluorine-containing solvent, that is allowable for the reuse is equal to or less than 300 mg/L, and preferably equal to or less than 100 mg/L.

The content of organic and inorganic ions, in the fluorine-containing solvent, that is allowable for the reuse differs depending on the usage, but for the use in semiconductor cleaning and drying, it is equal to or less than 10 ppm, and preferably equal to or less than 1 ppm.

The content of alcohol, in the fluorine-containing solvent, that is allowable for the reuse differs depending on the usage, but for the use in semiconductor cleaning and drying, it is equal to or less than 3.5% by mass, and preferably equal to or less than 1% by mass.

The present invention will be described below with examples, but the present invention is not limited to the following examples.

### EXAMPLES

In the present examples and comparative examples, the following reagents, instruments, and method were used.

### Fluorine-Containing Solvent

Methoxyperfluoroheptene isomeric mixture—Vertrel® Suprion
1,1,1,2,2,3,4,5,5,5-decafluoropentane—Vertrel® XF
Both are manufactured by Du Pont-Mitsui Fluorochemicals Co, Ltd.

### Alcohol

isopropyl alcohol (IPA)
ethanol
Both are manufactured by Wako Pure Chemical, Ltd., Wako first class.

### PTFE Filters

Advantec® PF100 (remaining particle size 10 μm)
Advantec® PF040 (remaining particle size 4 μm)
Advantec® PF020 (remaining particle size 2 μm)
All of the above are manufactured by Advantec Toyo Kaisha, Ltd.

### Determining Method of Alcohol Amount in Fluorine-Containing Solvent—Gas Chromatography

Using gas chromatography GC-2014 manufactured by SHIMADZU CORPORATION, alcohol concentration contained in the fluorine-containing solvent was measured by calibration curve method (by preparing a calibration curve using a sample in which the fluorine-containing solvent and alcohol are mixed at known concentrations).

### Determining Method of Metal Ion Concentration in Fluorine-Containing Solvent—ICP-MS

Approximately 20 g of the fluorine-containing solvent was heated at 120° C. to be vaporized, and the residue after the vaporization was extracted with approximately 20 g of nitric acid. Thereafter, various ion concentrations were determined with an inductively-coupled plasma mass spectrometer (ICP-MS. manufactured by Agilent Technologies).

### Determining Method of Anion Concentration in Fluorine-Containing Solvent—Ion Chromatography

Since an anion concentration in the fluorine-containing solvent cannot be determined directly, pure water that has been confirmed not to contain anions and the fluorine-containing solvent of the same amount of the pure water were mixed and shaken, and then an anion concentration (an anion concentration transferred from the fluorine-containing solvent) that was separated in the water was determined with ion chromatography, and the result of that was defined as an anion concentration in the fluorine-containing solvent.

The anion concentration in the water was determined with calibration curve method using ion chromatography (DX-320J) manufactured by Nippon Dionex K.K.

### Example 1

Approximately 50 g of a fluorine-containing solvent (Vertrel® Supurion), water, and isopropyl alcohol (IPA) with the compositions shown in Table 1 was weighed and stored in a sample vial, mixed by a shaking device, and thereafter agitated. A suspended and whity-clouded mixed liquid in which the fluorine-containing solvent was finely dispersed was obtained, and was filtered using a PTFE filter (PF020). A fluorine-containing solvent was obtained as a filtrate, and a water layer remained on the filter.

An alcohol concentration (% by mass) in the fluorine-containing solvent of the obtained filtrate was measured by the above method (gas chromatography). The results are shown in Table 1.

Particularly, it can be understood that alcohol could be separated with no problem even in the case of a sample, showing an azeotropic feature, which contains 40% of alcohol concentration with respect to water.

### Example 2

Determining was performed as with Example 1 except for filtering using a PTFE filter (PF040). The results are shown in Table 1.

### Example 3

Determining was performed as with Example 1 except for filtering using a PTFE filter (PF100). The results are shown in Table 1.

In this Example, the concentration of the fluorine-containing solvent, in a water phase that has remained on the filter was measured, and the concentration of the fluorine-containing solvent with alcohol concentration of 10% was 0.19%, the concentration of the fluorine-containing solvent with alcohol concentration of 20% was 0.25%, and the concentration of the fluorine-containing solvent with alcohol concentration of 40% was 0.53%. This result indicates that the fluorine-containing solvent hardly remained in the water layer on the filter.

### Example 4

Determining was performed as with Example 1 except for using a mixed liquid comprising a fluorine-containing solvent (Vertrel® XF), water, and ethanol (EtOH). The results are shown in Table 1.

### Example 5

Determining was performed as with Example 1 except for using a mixed liquid comprising a fluorine-containing solvent (Vertrel® XF), water, and ethanol (EtOH) and except for using a PTFE filter (PF040). The results are shown in Table 1.

### Example 6

Determining was performed as with Example 1 except for using a mixed liquid comprising a fluorine-containing solvent (Vertrel® XF), water, and ethanol (EtOH) and except for using a PTFE filter (PF100). The results are shown in Table 1.

### Comparative Example 1

A water solution containing isopropyl alcohol (IPA) of 50% by mass was prepared and filtered with a PTFE filter (PF100). The all solution passed through the filter and there was no residue on the filter. The results are shown in Table 1.

TABLE 1

| | | | | | | | Alcohol | |
|---|---|---|---|---|---|---|---|---|
| | | Composition ratio | | | | | concentration | |
| | Alcohol | Fluorine- | | | | | in fluorine- | |
| | concentration | containing | | | | | containing | |
| Example | to water | solvent | | Alcohol | | | solvent | Separation |
| No. (filter) | (% by mass) | Supurion | XF | IPA | EtOH | Water | (% by mass) | evaluation* |
| Example 1 | 1% | 50 | | 0.5 | | 49.5 | not detected | ⊚ |
| (PF020) | 10% | 50 | | 5 | | 45 | 0.12% | ⊚ |
| | 20% | 50 | | 10 | | 40 | 0.33% | ⊚ |
| | 30% | 50 | | 15 | | 35 | determining | determining |
| | | | | | | | was not done | was not done |
| | 40% | 50 | | 20 | | 30 | 0.99% | ◯ |
| | 50% | 50 | | 25 | | 25 | determining | Δ |
| | | | | | | | was not done | |
| Example 2 | 1% | 50 | | 0.5 | | 49.5 | 0.28% | ⊚ |
| (PF040) | 10% | 50 | | 5 | | 45 | 0.16% | ⊚ |
| | 20% | 50 | | 10 | | 40 | 0.34% | ⊚ |
| | 30% | 50 | | 15 | | 35 | 0.64% | ⊚ |
| | 40% | 50 | | 20 | | 30 | 1.40% | Δ |
| | 50% | 50 | | 25 | | 25 | determining | determining |
| | | | | | | | was not done | was not done |
| Example 3 | 1% | 50 | | 0.5 | | 49.5 | not detected | ⊚ |
| (PF100) | 10% | 50 | | 5 | | 45 | 0.12% | ⊚ |
| | 20% | 50 | | 10 | | 40 | 0.33% | ⊚ |
| | 30% | 50 | | 15 | | 35 | 0.57% | ⊚ |
| | 40% | 50 | | 20 | | 30 | 2.61% | Δ |
| | 50% | 50 | | 25 | | 25 | determining | determining |
| | | | | | | | was not done | was not done |
| Example 4 | 1% | | 50 | | 0.5 | 49.5 | determining | determining |
| (PF020) | | | | | | | was not done | was not done |
| | 10% | | 50 | | 5 | 45 | 0.32% | ⊚ |
| | 20% | | 50 | | 10 | 40 | 0.69% | ⊚ |
| | 30% | | 50 | | 15 | 35 | determining | determining |
| | | | | | | | was not done | was not done |
| | 40% | | 50 | | 20 | 30 | 2.14% | ⊚ |
| | 50% | | 50 | | 25 | 25 | 3.43% | Δ |
| Example 5 | 1% | | 50 | | 0.5 | 49.5 | 0.03% | ⊚ |
| (PF040) | 10% | | 50 | | 5 | 45 | 0.40% | ⊚ |
| | 20% | | 50 | | 10 | 40 | 0.66% | ⊚ |
| | 30% | | 50 | | 15 | 35 | 1.52% | ⊚ |
| | 40% | | 50 | | 20 | 30 | 1.77% | Δ |
| | 50% | | 50 | | 25 | 25 | determining | determining |
| | | | | | | | was not done | was not done |
| Example 6 | 1% | | 50 | | 0.5 | 49.5 | 0.03% | ⊚ |
| (PF040) | 10% | | 50 | | 5 | 45 | 0.35% | ⊚ |
| | 20% | | 50 | | 10 | 40 | 0.69% | ⊚ |
| | 30% | | 50 | | 15 | 35 | 1.49% | ⊚ |
| | 40% | | 50 | | 20 | 30 | 1.44% | Δ |
| | 50% | | 50 | | 25 | 25 | determining | determining |
| | | | | | | | was not done | was not done |
| Comparative | 50% | | | 50 | | 50 | | X |
| Example 1 | | | | | | | | |
| (PF100) | | | | | | | | |

*Evaluation standard of fluorine solvent separation
⊚: Only clear fluorine solvent can be separated.
◯: A fluorine solvent layer can be separated but is slightly whity-clouded.
Δ: A fluorine solvent layer can be separated and can be used with no problem, but a water phase is mixed into the fluorine solvent or the fluorine solvent is whity-clouded.
X: Separation cannot be done.

### Example 7

Using a fluorine-containing solvent (Vertrel® Supurion) which contains metal ions and has been stored in a metal container for long time, ultra-pure water and the fluorine-containing solvent are mixed at a mass ratio of 1 to 1 and thereafter filtered with a PTFE filter (PF100). A metal ion concentration in the fluorine-containing solvent obtained as filtrate was determined by the above method (ICP-MS). A metal ion concentration in the fluorine-containing solvent before the filtering process was also determined. The results are shown in Table 2.

TABLE 2

| | Before process | After process |
|---|---|---|
| Amount of fluorine- | 21.75 | 20.48 |
| containing solvent [g] | | |
| Amount of nitric acid [g] | 22.23 | 20.51 |
| Respective ion | | |
| concentrations [ppt] | | |
| Li | 22 | detection limit or below |
| B | 4602 | 21 |
| Na | 1474 | 18 |
| Mg | 335 | detection limit or below |
| K | 591 | detection limit or below |
| Ca | 3567 | detection limit or below |
| Co | 55 | detection limit or below |
| Cu | 355 | detection limit or below |
| Zn | 708 | detection limit or below |
| Mo | 157 | detection limit or below |
| Ag | 373 | detection limit or below |

### Reference Example 1

100 g of a standard solution (anion mixed solution II manufactured by Wako Pure Chemical, Ltd.) containing chlorine ion (Cl—) of 200 ppm, fluorine ion (F—) of 50 ppm, and sulfate ion (SO4—) of 100 ppm and 100 g of a fluorine-containing solvent (Vertrel® Supurion) were put in a separating funnel, and agitated by the shaking device for approximately 30 minutes. After the agitation, the separating funnel was placed statically to be observed to confirm that the separation was completed. Then, 80 g of the separated fluorine-containing solvent was transferred into a sample vial and was mixed with the same 80 g of pure water, which was the same amount with the fluorine-containing solvent, and an anion concentration in the fluorine-containing solvent was determined by the above method. In the same manner, 200 g of the standard solution and 100 g of a fluorine-containing solvent were put in a separating funnel, and the same process was repeated. The results are shown in Table 3.

TABLE 3

| | |
|---|---|
| | anion concentration in fluorine- |
| | containing solvent layer |
| | Mixed ratio (fluorine-containing |
| Ion concentration | solvent:standard solution) |

| | in standard solution | 1:1 | 1:2 |
|---|---|---|---|
| Cl⁻ | 200 ppm | 0.12 ppm | 0.22 ppm |
| SO⁴⁻ | 100 ppm | not detected | not detected |
| F⁻ | 50 ppm | 0.04 ppm | 0.06 ppm |

Anions are hardly transferred to the fluorine-containing solvent, and even if a small amount of anions is transferred, it is transferred to water layer by cleaning with water, and therefore anions can be easily filtered, from the fluorine-containing solvent, together with alcohol (since anions remain on the membrane containing fluorine resin).

### INDUSTRIAL APPLICABILITY

According to the separating method of a fluorine-containing solvent of the present invention, not only alcohol but also organic and inorganic ions can be removed at the same time, and efficient regeneration of the fluorine-containing solvent can be achieved, and therefore the present invention is effectively utilized for reuse of the fluorine-containing solvent that has been used in a field, particularly in semiconductor cleaning, which uses a large amount of the fluorine-containing solvent.

1. A method for separating a fluorine-containing solvent comprising filtering a two-phase mixed liquid composition containing the fluorine-containing solvent, alcohol and water with a membrane containing a fluorine resin.

2. A method for removing an alcohol-containing contaminant from a fluorine-containing solvent, the method comprising:
adding and mixing water into the fluorine-containing solvent containing the alcohol-containing contaminant to prepare a two-phase mixed liquid composition containing the fluorine-containing solvent, the alcohol, and the water; and thereafter
separating the fluorine-containing solvent by filtering the two-phase mixed liquid composition with a membrane containing fluorine resin.

3. The method according to claim 1 or 2, wherein the fluorine-containing solvent is a hydrofluorocarbon or a hydrofluoroether.

4. A filtration separation apparatus for performing the method according to any one of claims 1 to 3, the filtration separation apparatus comprising a membrane containing fluorine resin.

5. A cleaned fluorine-containing solvent that is obtained by the method according to any one of claims 1 to 3.

6. The fluorine-containing solvent according to claim 5, wherein the fluorine-containing solvent is for semiconductor cleaning.
